(19) United States
(12) Patent Application Publication
(10) Pub. No.: US 2005/0190038 A1
(43) Pub. Date: Sep. 1, 2005

(54) Method and set for the identification of animals

(76) Inventor: Marc Parthoens, Olne (BE)

Correspondence Address: BLANK ROME LLP, 600 NEW HAMPSHIRE AVENUE, N.W., WASHINGTON, DC, 20037, US

(21) Appl. No.: 11/064,954

(22) Filed: Feb. 25, 2005

(30) Foreign Application Priority Data
Feb. 27, 2004 (EP) 2004EP-100791

(51) Int. Cl. G05B 19/00

(52) U.S. Cl. 340/5.8; 340/10.1; 340/573.1

(57) ABSTRACT

Method for identifying an identified comprising the affixing to said identified of a first transponder, comprising a first identifier and the marking of a printed identification document of the identified by means of a second transponder comprising a second identifier linked univocally to said first identifier, and set for identifying an identified, comprising a first transponder encoded with a first identifier and a printed identification document of the identified marked by a second transponder comprising a second identifier linked univocally to said first identifier. Since the two transponders comprise identifiers linked univocally to one another and preferably non-falsifiable, it can be ensured that the printed identification document does indeed correspond to the identified.

### REFERENCE DATA

This application claims priority from European patent application No 2004EP-100791 filed on Feb. 27, 2004, the contents of which are hereby incorporated by reference.

### FIELD OF THE INVENTION

The present invention concerns a method and a set for the identification of animals. The present invention concerns in particular a method and a device for the identification of pets with the aid of passports.

### DESCRIPTION OF RELATED ART

More and more countries, in particular among European countries, impose or recommend that animals, notably pets, be identified for example by a transponder and registered in a database, thus making it possible if necessary to find the owner of or person responsible for the animal.

Two ISO norms concerning the characteristics of the transponders to be used for this purpose have for example been established:
ISO 11784, completed by ISO 3166
ISO 11785

They are practically unanimously accepted in all of the European countries.

Furthermore, a European Rule that will come into force on Jul. 3, 2004, prescribes that pets traveling in the member states or coming from third countries will have to be accompanied by a passport that thus aims to ensure a sufficient security level as regards sanitary risks.

On state level, fraud prevention as well as traceability in the animal field are also on the agenda.

A passport for animals is a document containing the animal's identification data. It can also contain its sanitary data, its medical history and other information pertaining to it.

Yet prior art identification methods such as for example that described in the mentioned European Rule do not make it possible to be sure that the passport presented for an animal actually corresponds to that animal. A solution adopted by these methods is for example to affix in the passport a photo of the animal to identify. However, such a solution has several disadvantages. First, it is poorly reliable since it is for example relatively easy to change the photograph of a passport without the forgery being visible. Furthermore, identifying an individual from a photograph, which is already sometimes difficult for a human being, is even more difficult for an animal, and this difficulty increases further as the animal gets older. The photograph must moreover be of good quality, which is generally relatively expensive, and correctly centered, which can be difficult and time-consuming to achieve with animals.

More generally, no prior art identification and/or sanitary document makes it possible to know whether the animal presented does indeed correspond to the one indicated in the passport.

An aim of the invention is thus to propose a method and a set for the identification of animals enabling to remedy the disadvantages of the prior art methods and devices.

Another aim of the invention is to propose a method and a set allowing a simplified and reliable identification of the animals to be ensured.

One solution to avoid using the poorly reliable passports of the prior art would be to store all required information regarding the animal in the transponder fastened to it. Such a solution however has the disadvantage that the transponder should then have sufficient memory for storing all these data, which implies a high cost and a relatively large size of the transponder. Furthermore, the data could not be read at any time, since their access would mandatorily require the use of an adapted reader.

A passport or any other printed identity document thus remains useful for a quick verification, for example, of the data concerning the animal, reading the transponder being performed only in case of doubt as to the authenticity of these data.

### BRIEF SUMMARY OF THE INVENTION

The aims of the invention are thus achieved by a method and by an identification set having the characteristics of the corresponding independent claims, advantageous embodiments being further given by the dependent claims.

These aims are achieved in particular by a method for identifying an identified, comprising the affixing to said identified of a first transponder comprising a first identifier and the marking of a printed identification document of the identified by means of a second transponder comprising a second identifier linked univocally to said first identifier, and by a set for identifying an identified comprising a first transponder encoded with a first identifier and a printed identification document of the identified marked by a second transponder comprising a second identifier linked univocally to said first identifier. Since the two transponders comprise identifiers linked univocally to one another and preferably non-falsifiable, it can be ensured that the printed identification document does indeed correspond to the identified.

The invention relates in particular to a passport for animal identified by a fraud-proof transponder comprising an identifier that can be associated univocally to an identifier contained in the identification transponder injected into the animal, in order to avoid that this passport can be presented with an animal to which it does not pertain.

### DETAILED DESCRIPTION OF THE INVENTION

According to a preferred embodiment of the invention, the animal identification device comprises a passport identified by a fraud-proof transponder containing for example the same number as the identification transponder injected in the animal, these two transponders being preferably capable of being read with a same standard reader.

According to this embodiment, the invention thus makes it possible to check that the passport presented does indeed correspond to the animal for which it contains the information by comparing the two numbers, that of the animal and that of the passport, and by checking that they are identical.

According to this embodiment, any person or administration affected by the animals, such as for example the authorities, veterinarians, animal protection societies, etc. are preferably able to ask for the passport of the checked animal, to read the transponder injected in the animal, to read the transponder contained in the passport and to compare the numbers which, if they are identical, will guarantee that the passport presented in fact corresponds to the animal in question. The reading of the two transponders is preferably performed by means of the same standard transponder reader.

In this manner, this passport allows any person or administration affected by the animals to detect any error or attempt at fraud, and to take the necessary measures. For any additional information, this person or administration can preferably contact a database in which the animal is registered in order to ascertain that the data indicated in the passport, for example the identity of the owner of or person responsible for the animal, are indeed up-to-date.

One advantage of the inventive solution is that it allows if needed an easier access to data that do not appear, for example for reasons of space and/or confidentiality, on the printed document. These additional data are for example stored in the two transponders, in one of the two transponders if they are of different types and/or in a database that is preferably accessible remotely, in a registration associated for example univocally to the identifier contained in at least one of the two transponders.

Certain data of sensitive or confidential nature are thus for example stored only in the first and/or in the second transponder. They are then accessible only by means of a suitable reader, thus preventing them to be easily accessed by a non-authorized person. Confidential data can also be stored in the database. Their access is then preferably protected by a password. These confidential data include for example the animal's blood group, its veterinary file, etc.

For reasons of space, certain data are for example stored only in one of the two transponders or in the database, the quantity of information being for example too large for it to be entirely reproduced on the printed document.

According to the invention, at least part of the data pertaining to the animal and/or to its owner or responsible person is registered in a database, administered for example by a state administration or a private organization, and collecting preferably data concerning all the animals identified in a region or in a country. For reasons of confidentiality and/or space, some information is then preferably registered only in this database.

The database is preferably a central database regrouping information concerning all the elements identified according to the invention in a region or country. It is for example implemented on a computer server and administered by a public regional or national administration, or by a private organization, for example under mandate from a public administration. The database can preferably be reached remotely in computerized manner, for example through an internet connection, fixed line or mobile telephone connection etc., for example by means of a PC, of a telephone or any other communication terminal, so that at least part of the data it contains is accessible for example during identity controls of the identified, for example of the animal. Thanks to such a remote connection, certain data can be sent electronically to the database and be recorded there directly, for example during initial identification of the animal by a veterinarian.

The first transponder designed to be affixed to the identified preferably contains a minimal quantity of information, so that the size of its memory and the power required for reading it is as small as possible, in particular if it is to be injected under an animal's skin. It will then contain the first identifier and possibly certain basic information such as for example the blood group and species of the animal. The memory of the first transponder is preferably of the type OTP (One Time Programmable) or ROM (Read-Only Memory), so that the information recorded can no longer be modified. In the case of ROMs, certain information particular to the identified and generally immutable can however be added after initial programming, such information being for example the dates of vaccination of the animal, etc.

According to a first embodiment, the second transponder uses a technology identical to the first and contains the second identifier and possibly at least part of the additional information contained in the first transponder. According to another embodiment, the size of the memory of the second transponder is greater and contains more information than the first. Its memory is however preferably always of the type ROM or OTP.

The database preferably takes over all the information contained in the transponders and in the printed identification document. It however further advantageously contains information capable of being modified such as for example the address of the owner of or responsible for the identified, and/or large-size information, for example the animal's veterinary file, etc.

The first and second identifiers are linked univocally. According to a first embodiment, these two identifiers are identical. They are for example the same unique numerical identification code allocated for example to the identified. According to another embodiment, the identifiers are linked by a mathematical conversion function and/or by a same encryption that can for example be decoded by the transponder reader. The data pertaining to the identified stored in the database are preferably also associated to an identifier linked univocally to the first identifier and/or to the second identifier, so that the link between these data and the identified can be made in a sure manner.

The database preferably contains the data pertaining to the identified and/or its owner or person responsible for it.

Transponder is the abbreviation of the English terms TRANSmitter & resPONDER.

It is an electronic element that allows a specific signal to be received and a specific response to be automatically transmitted.

It is generally constituted of a microchip that contains the information, of a capacitor and of an antenna.

It can be active or passive.

Within the framework of animal identification:
the microchip contains for example a fifteen digit code (ISO transponder);
the three constitutive elements are for example enclosed in a minute glass tube that is biologically compatible and can be injected into the animal;
it is of passive type.

Within the framework of the invention, the transponder allowing the passport to be identified preferably complies with the following criteria:
the three constitutive elements are united in such a manner that they can be integrated in the passport, for example glued or inserted in the cover, on one of the pages or at any other place in the passport without it being possible to remove them without rendering them unusable and/or without leaving traces of the manipulation on the passport itself;
it is preferably of the OTP (One Time Programmable) type, a technique that allows only a single writing of the number without possibility of ulterior modification, thus ensuring a better protection against falsification;
in order to ensure that the transponder used for identifying the passport can be read without difficulty by a standard reader such as for example that described in the aforementioned norm ISO 11785, the technical characteristics are preferably identical to the technical characteristics of the transponder implanted in the animal, for example as concerns the animal bit described in the norm ISO 11784 previously mentioned.

According to this preferred embodiment of the invention, the passport is identified by a transponder offering optimal protection against fraud and containing an identifier that can be linked univocally to the identifier of the identification transponder injected in the animal, these two transponders being preferably readable with the same standard reader.

The identifier of the transponder identifying the passport is preferably encoded according to the OTP (One Time Programmable) technique or to any other technique that prevents this number from being modified once it has been recorded in the transponder. It is for example inscribed in a ROM (Read-Only Memory) allowing for example supplemental information to be added without allowing them to be erased. The moment at which the transponder is encoded depends on the initial identification process, the problem being to ensure in an easy and sure way that the two transponders associated with the animal and its passport are indeed encoded with identifiers linked together univocally.

According to a variant embodiment of the invention, the passport is established after the first identification of the animal.

According to this embodiment, the person in charge of the initial identification of the animal, for example a veterinarian
proceeds to identify the animal by injecting a transponder comprising an identifier, for example a unique identification code,
fills in an identification sheet, for example a printed or electronic sheet, by adding the identifier of the transponder injected in the animal and preferably the animal's characteristics and the address of its owner or of the personal responsible for it;
preferably sends this information to a central database, a database for example chosen or imposed by a national regulation.

Upon receipt of this information, the administration system of the database
manually and/or automatically records the received data,
proceeds to write in an identification transponder for passport, preferably according to an OTP method or any other method that does not allow the inscriptions to be modified, an identifier linked univocally to the identifier indicated on the received identification sheet and contained in the transponder injected in the animal, these two identifiers being for example a same unique identification code,
establishes a printed identification document, for example a passport, on which appear at least part of the recorded data pertaining to the animal and identified by the previously encoded transponder,
sends this identification document to the owner of or to the person responsible for the animal holder of the passport.

According to another variant embodiment of the invention, the identification document is established before the first identification of the animal.

According to this embodiment, the agency responsible for establishing the passports, which is preferably also responsible for the database administration system, preferably sends the following elements to the veterinarian or to any other person and/or administration in charge of the first identification of the animal:
a first transponder to be injected in the animal, containing an identifier, for example a unique numerical code, recorded for example by the transponder's manufacturer;
a passport capable of being identified by a second transponder containing an identifier linked univocally to the identifier of the first transponder, for example the same numerical code, the second transponder being preferably linked to the passport, for example integrated within its cover, glued onto one of its pages, etc., in such a way that it cannot be removed without being damaged and/or without leaving traces of the manipulation on the passport;
an identification sheet to be completed, for example a paper or electronic sheet.

The veterinarian or any other person and/or administration in charge of the first identification of the animal
proceeds to the initial identification of the animal by injecting the first transponder received,
fills in the identification sheet received with the identifier of the transponder injected in the animal and preferably with some supplemental indications such as for example the animal's characteristics and/or the address of its owner or of the personal responsible for it;
sends this information to a central database, a database for example chosen or imposed by a national regulation;
possibly fills in the printed identification document, for example the passport, and gives it preferably to the owner of or person responsible for the animal.

Upon receipt of the identification sheet, the agency responsible for the database administration system
records the received data,
optionally sends to the owner of or person responsible for the animal holder of the passport a confirmation of recording reproducing at least part of the recorded data; this confirmation is then for example glued or inserted in the passport.

According to a variant embodiment of this latter method, the distribution of the first transponder intended to be injected into the animal and the distribution of the printed document identified by a second transponder containing an identifier linked univocally to the identifier of the first transponder occur through different channels. The veterinarian or any other person and/or administration in charge of the first identification of the animal receiving these elements is then preferably able to check that the two transponders received are indeed encoded correctly before proceeding to identify the animal.

According to yet another variant embodiment of the invention, the transponders intended to identify the animal and the passport are distributed independently of the passport itself. According to this embodiment, the three elements (passport, transponder identifying the animal, transponder identifying the passport) are distributed by different channels, with the veterinarian or any other person and/or administration in charge of the first identification of the animal receiving these elements is then preferably in a position to check that the two transponders received have indeed been encoded correctly before proceeding to identify the animal and establish the passport. This embodiment has the advantage that the method of the invention can thus easily be associated to any prior art method for distributing the animal passport without requiring these methods to be changed.

According to the embodiments of the present invention described here above, the inventive identification device comprises a passport for animals that is identified univocally and practically non-falsifiably by a transponder. The one skilled in the art will however understand that the principle of the invention can be applied to any other identification document, in paper or electronic form, comprising in its structure a transponder that displays when read a number linked univocally, for example identical, to that contained in the transponder affixed or grafted on the animal to identify.

The method of the invention has been described here above in the framework of the identification of animals, in particular of pets. The invention can however be applied to the identification of other entities, for example of objects such as works of art, computer software, data carriers, mechanical pieces, meat parts, etc. Generally, the principle of the invention can be applied to the identification of any element associated to a printed identification document, for example to a passport or to a certificate of authenticity.

According to a variant embodiment of the invention, a same printed identification document, for example a same passport or a same certificate of authenticity, is used for several identifieds, for example for identifying all the software of a same series with a single printed certificate. Each identified then preferably comprises a transponder containing a same identifier.

The invention thus relates to a method for identifying an identified, comprising the affixing to said identified of a first transponder comprising a first identifier and the marking of a printed identification document of the identified with the aid of a second transponder comprising a second identifier linked univocally to said first identifier.

According to a preferred embodiment of the invention, the identified is a pet, for example under whose skin the first transponder is injected.

According to a preferred embodiment of the invention, the printed identification document is a passport.

Preferably, the marking of the printed identification document is performed so that it cannot be modified and/or cancelled without the identification device and/or the second transponder being altered.

According to an identification method of the invention, the first transponder is affixed to the identified before the identification device is marked by means of the second transponder. The second transponder is then preferably encoded with its second identifier after affixing, according to the first identifier comprised in the second transponder.

The first identifier and/or the second identifier are preferably recorded in a database further comprising information pertaining to the identified and/or its owner or person responsible for it.

The first transponder and the second transponder can preferably be read by a same reader. In order to avoid any fraud or falsification, the first transponder and/or the second transponder are preferably of the OTP or ROM type. They further preferably comprise supplemental information pertaining to the identified and/or its owner or person responsible for it.

The present invention also concerns a set for the identification of an identified, comprising a first transponder encoded with a first identifier and a printed document identifying the identified marked by a second transponder comprising a second identifier linked univocally to said first identifier. In order to avoid any fraud or falsification, the first transponder and/or the second transponder are preferably of the OTP or ROM type. The printed identification document is for example a passport.

1. A method for identifying an identified, comprising the affixing to said identified of a first transponder comprising a first identifier and the marking of a printed identification document of the identified by means of a second transponder comprising a second identifier linked univocally to said first identifier.

2. The method of claim 1, said identified being an animal.

3. The method of claim 2, said affixing comprising the injection of said first transponder under the skin of said animal.

4. The method of claim 1, said printed identification document being a passport.

5. The method of claim 1, said marking being performed so that it cannot be modified and/or cancelled without the identification device and/or the second transponder being altered.

6. The method of claim 1, said affixing of said first transponder to said identified occurring before said printed identification document is marked by means of said second transponder.

7. The method of claim 6, said second transponder being encoded with said second identifier after said affixing, according to said first identifier.

8. The method of claim 1, the marking of said identification device by means of said second transponder occurring before said affixing of said first transponder to said identified.

9. The method of claim 8, said first transponder being encoded with said first identifier after said marking, according to said second identifier.

10. The method of claim 1, said first identifier and/or said second identifier being recorded in a database, said database further comprising information pertaining to said identified and/or its owner or person responsible for it.

11. The method of claim 1, said first transponder and said second transponder being readable by a same reader.

12. The method of claim 1, said first transponder being of the type OTP.

13. The method of claim 1, said second transponder being of the type OTP.

14. The method of claim 1, said first transponder and/or said second transponder further comprising information pertaining to said identified and/or its owner or person responsible for it.

15. A set for identifying an identified comprising a first transponder encoded with a first identifier and a printed identification document of the identified marked by a second transponder comprising a second identifier linked univocally to said first identifier.

16. The set of claim 15, said first transponder and/or said second transponder being of the type OTP.

17. The set of claim 15, said printed identification document being a passport.
